(19) United States
(12) Patent Application Publication
(10) Pub. No.: US 2025/0048009 A1
(43) Pub. Date: Feb. 6, 2025

(54) Playback Device with Reconfigurable Supports

(71) Applicant: Sonos, Inc., Goleta, CA (US)

(72) Inventors: Michael Megna, Santa Barbara, CA (US); Jethro Tsai, Santa Barbara, CA (US); Jonathan Oswaks, Santa Barbara, CA (US); Eduardo Salazar, Santa Barbara, CA (US); Louis Lundell, Santa Barbara, CA (US); Quinn Huffstetler, Santa Barbara, CA (US)

(21) Appl. No.: 18/793,537

(22) Filed: Aug. 2, 2024

Related U.S. Application Data
(60) Provisional application No. 63/517,560, filed on Aug. 3, 2023.

(51) Int. Cl. H04R 1/02

(52) U.S. Cl. CPC H04R 1/026; H04R 1/021; H04R 2201/029

(57) ABSTRACT

A reconfigurable support for a playback device includes (i) a first side configured for magnetic engagement with a recessed ledge of a recess formed in a bottom surface of a housing, the recess comprising a perimeter, and the recessed ledge extending about at least a portion of the perimeter of the recess, and (ii) a second side opposite the first side, configured for magnetic engagement with the recessed ledge and having an edge surrounding a resilient protrusion that extends outward from a plane of the edge. When the reconfigurable support is positioned within the recess in a first configuration, the first edge is magnetically engaged with the recessed ledge and the resilient protrusion extends outward from the bottom surface of the housing; however, in a second configuration the second edge is magnetically engaged with the recessed ledge and the resilient protrusion is contained within the recess.

### CROSS-REFERENCE TO RELATED APPLICATIONS

This application claims priority to U.S. Provisional Application No. 63/517,560, filed Aug. 3, 2023, and titled “Playback Device with Reconfigurable Supports,” the contents of which are incorporated herein by reference in their entirety.

### FIELD OF THE DISCLOSURE

The present disclosure is related to consumer goods and, more particularly, to support assemblies that may be used for positioning consumer goods, such as playback devices for the purpose of media playback.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. In addition, Sonos has continued to innovate around ways to physically incorporate playback devices into a listening environment, including innovations around playback device size, shape, configuration, and placement.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example playback device.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example media playback system zones.

FIG. 1N is a schematic diagram of example media playback system areas.

FIG. 2 is a diagram of an example headset assembly for an example playback device.

FIG. 3 is an isometric diagram of an example playback device housing.

FIG. 4A is a view of a first example playback environment having a playback device configured in a first positioning configuration.

FIG. 4B is a view of the example playback environment of FIG. 4A having the playback device configured in a second positioning configuration.

FIG. 5A is a perspective view of a first example reconfigurable support for a playback device.

FIG. 5B is a side view of the first example reconfigurable support device for the playback device of FIG. 5A.

FIG. 6A is a top-down view of an example recess in a housing for a playback device and illustrates the location of the cross-section shown in FIG. 6B.

FIG. 6B is a first cross-sectional view of the example recess of FIG. 6A, with which the first example reconfigurable support engages, the illustration of FIG. 6B showing the reconfigurable support removed from the recess.

FIG. 6C is a second cross-sectional view of the example recess of FIG. 6A, the illustration of FIG. 6C showing the reconfigurable support engaged with the recess in a first configuration for the reconfigurable support.

FIG. 6D is a third cross-sectional view of the example recess of FIGS. 6A-6C, the illustration of FIG. 6D showing the reconfigurable support engaged with the recess in a second configuration for the reconfigurable support.

FIG. 7A is a perspective view of a second example reconfigurable support for a playback device.

FIG. 7B is a side view of the second example reconfigurable support device for the playback device of FIG. 7A.

FIG. 8A is a top-down view of another example recess in a housing for a playback device and illustrates the location of the cross-section shown in FIG. 8B.

FIG. 8B is a first cross-sectional view of the example recess of FIG. 8A, with which the second example reconfigurable support engages, the illustration of FIG. 8B showing the reconfigurable support removed from the recess.

FIG. 8C is a second cross-sectional view of the example recess of FIGS. 8A-8B, the illustration of FIG. 8C showing the reconfigurable support engaged with the recess in a first configuration for the reconfigurable support.

FIG. 8D is a third side cross-sectional view of the example recess of FIGS. 8A-8C, the illustration of FIG. 8D showing the reconfigurable support engaged with the recess in a second configuration for the reconfigurable support.

FIG. 9A is a top-down view of another example recess in a housing for a playback device and illustrates the location of the cross-section shown in FIG. 9B.

FIG. 9B is a first cross-sectional view of the example recess of FIG. 9A,, the illustration of FIG. 9B showing the reconfigurable support removed from a recess in the housing.

FIG. 9C is a second cross-sectional view of the example recess of FIGS. 9A-9B, the illustration of FIG. 9C showing the reconfigurable support positioned within the recess in the second configuration.

FIG. 9D is a third cross-sectional view of the example recess of FIGS. 9A-9C, the illustration of FIG. 9D showing the reconfigurable support positioned within the recess in the second configuration and being engaged with by a user for removal.

FIG. 9E is a fourth cross-sectional view of the example recess of FIGS. 9A-9D, the illustration of FIG. 9D showing the reconfigurable support positioned within the recess in the first configuration and being engaged with by a user for removal.

FIG. 10A is a fifth cross-sectional view of the example recess of FIGS. 9A-9E, the illustration of FIG. 10A showing the reconfigurable support positioned within the recess in the first configuration and flexibly affixed to the housing via a flexible tether.

FIG. 10B is a sixth cross-sectional view of the example recess of FIGS. 9A-10A, the illustration of FIG. 10B showing the reconfigurable support positioned within the recess in the second configuration and flexibly affixed to the housing via the flexible tether.

FIG. 11 is a flowchart showing example operations for detecting positioning of the removable support(s) of FIGS. 4-10B and subsequent alerting of said positioning to a user of the playback device of FIGS. 4-10B.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Examples described herein involve reconfigurable support features for electronic devices (such as media playback devices) that can provide adequate support for the electronic device, when positioned on a surface, while also allowing for safe-keeping and out-of-sight storage of the support features, when surface positioning is not desired. Particularly, such reconfigurable support features are useful when a playback device (e.g., a sound bar, a smart speaker, and the like) is configured both for use on a surface (e.g., an entertainment center, a credenza, a table, a desk, etc.) and for mounted use, such as a soundbar mounted to the bottom of a display or a soundbar or smart speaker mounted directly to a wall or other surface of a space.

Typically, playback devices that can be mounted include or are packaged with a support apparatus for positioning the electronic device on a surface. For example, modern flat-screen televisions often include a stand, a set of feet, or other positioning assembly that can be affixed to the back and/or bottom of the television, for secure positioning within the entertainment space. However, if/when a user decides to mount the television to a wall in the entertainment space, the user, generally, removes the stand, by, for example, removing fasteners for parts of the stand. Then, if the user ever wishes to dismount the television from the wall, he/she/they must recall where the stand was stored (if it was kept at all), where all the fasteners thereof were placed, and, generally, must maintain a level of personal organization that is not common of most average users or consumers. Simply put, users of mountable playback devices often lose removable stands for these devices after mounting the device, leaving them forced to either purchase a new stand, if available, or create their own solution for positioning the device, when they no longer wish to have it wall-mounted.

With respect to the example of a soundbar, a smart speaker, or another type of mountable loudspeaker, such devices may rest on positioning features or supports, such as feet of the device or housing thereof, that are attached to an underside portion of the device, when the device is placed on a surface. However, when the device is to be mounted on a wall or on another device (e.g., a display or television), the supports may stick out from the bottom of the device, which may not only cause displeasing visual aesthetics, but may be disruptive to the entertainment environment (e.g., protrusions taking up space needed for other devices, protruding feet being susceptible to hooking onto or otherwise unwantedly-attaching to other devices or passing-by users or beings, and/or protruding feet may be prime targets of child or pet interest, with potential undesirable results, among other disadvantages of protruding feet on a mounted device).

One common approach, utilized by manufacturers of devices like televisions as noted above, is to simply make the feet removable, so that they are out of sight and mind when the device is mounted. This requires that the user store the feet in a location where the feet can be readily available if the user later decides to re-position the device on a surface. Similar to the above example of a wall-mounted television, in these scenarios, the feet or their associated fasteners are often lost, discarded, or damaged, by the user, when detached from the device and, thus, the flexibility of mounted use versus surface use of the device may be diminished.

In some other examples of removable or hidable supports in electronic devices, the manufacturer may utilize a mechanical device, such as a hinge, that is selectively configurable, based on whether the device is placed on a surface or on a wall. However, using such mechanical devices may cause greater manufacturing complexity for the electronic device and, still, in many examples the selectively configurable supports, when in the “mounted” selectable position, may still be visible or otherwise protruding from the device; thus, not eliminating the above-described disadvantages of protruding supports in an electronic device, when positioned via a mount.

To address these shortcomings, disclosed herein is a reconfigurable support mechanism for electronic devices, such as playback devices, that is configurable for both mounted and surface positioning, without experiencing the drawbacks of the described, legacy solutions. To that end, the reconfigurable mounts, disclosed herein, are configured for positioning in at least two-positions: (i) a first position, wherein a resilient protrusion extends outward from a bottom side of a housing for the electronic device and the reconfigurable support magnetically engages with the housing to maintain positioning, and (ii) a second position, wherein the resilient protrusion is positioned within a recess of the housing, the reconfigurable support magnetically engages with the housing at a position of the recess, and a side of the reconfigurable support, opposite of the side associated with the resilient protrusion, is substantially flush with the surface of the housing.

For surface positioning, the reconfigurable support(s) may be positioned in the first or “surface” configuration, such that the electronic device rests on the resilient protrusion(s) and is slightly elevated above the surface. Such an elevation may be configured for or be useful for one or more of thermal mitigation purposes or for acoustic fidelity purposes. Further, if the user decides to wall mount the electronic device, the reconfigurable supports can have their positions changed from the first configuration to the second “mounted” configuration, which stows the feet, for later use in the surface positioning, without the feet causing any unnecessary protrusions from the housing. These features will be better understood when described with respect to the drawings, below.

Accordingly, by utilizing the reconfigurable supports, a user has the flexibility to position his/her/their electronic device in any number of mounted or surface positioned environments, without having unnecessary risk of loss or damage to the supports. Thus, a consumer or user of the electronic device will have greater peace of mind, with respect to future use or future use by another of the device, as the positioning features can either be in use (surface position) or stowed away safely within the recess(es) in the housing (mounted position), without unnecessary risk of loss or damage to the reconfigurable supports. In fact, in some examples, the reconfigurable supports may be provided with further safe keeping features, via the use of a flexible tether, which allows for the feet to remain tethered to the device, whether the feet are in either the first configuration or the second configuration, or, further still, if the feet are magnetically disengaged from the housing.

Further, the resilient protrusion may also be configured for one or more of thermal performance for the electronic device, acoustic performance or fidelity of the electronic device, prevention of consequences of vibration (e.g., device “walking,” with respect to a surface), among other things. To that end, the resilient protrusion may be configured with a height that is configured for providing enough separation between the surface and the bottom of the electronic device for proper cooling. In such examples, the height may be configured such that one or more of a fan, a heat sink, a vent, or combinations thereof, of the electronic device has enough room underneath the device for proper air ingress and heat egress. Further still, the height may be configured such that an acoustic performance or fidelity for the device, when it is an audio playback device, is not compromised by an audio driver resting too close to the surface. In some examples, said device height may be in a range of about XX millimeters (mm.) to about XXX mm. Additionally, as mentioned above, the resilient protrusion may be configured to mitigate consequences of a device being vibrated by electronic components (e.g., audio drivers), by being comprised of one or more materials configured to hold the playback device substantially static, with respect to the surface, when positioned in the surface sitting position. Such materials may include, but are not limited to including, a rubber material, silicone, . . . , or combinations thereof.

Further still, while the removable supports and features thereof are, generally, described for positioning in the two described configurations, other configurations are certainly possible. For example, the reconfigurable supports may be reconfigured in vertical versus horizontal configurations, for devices that can be placed on a surface in different orientations. Additionally or alternatively, in some examples, additional recesses may be configured in the housing, such that the reconfigurable supports may attach to the device on another side, (e.g. a side foot mount rather than the regular bottom foot mount). Additionally or alternatively, the described features of the reconfigurable supports may be applicable to other features of the device such as, but not limited to, removable batteries and/or battery covers of the device, a stowable remote control of the device, among other possibilities.

As indicated above, the examples herein involve reconfigurable supports for an electronic device that allow for mounting or positioning flexibility for the electronic device. In one aspect a computing device is provided that includes (i) one or more electronic components, (ii) a housing configured for enclosing, at least in part, the one ore more electronic components, and (iii) a reconfigurable support. The housing includes (i) a bottom surface, and (ii) a recess formed in the bottom surface of the housing, the recess comprising a perimeter and a recessed ledge extending about at least a portion of the perimeter of the recess. The reconfigurable support includes (i) a first side comprising a first edge that is substantially planar, and (ii) a second side opposite the first side comprising a second edge that is substantially planar and parallel to the first edge, the second edge surrounding a resilient protrusion that extends outward from a plane of the second edge, wherein (a) when the reconfigurable support is positioned within the recess in a first configuration, the first edge is magnetically engaged with the recessed ledge and the resilient protrusion extends outward from the bottom surface of the housing, and (b) when the reconfigurable support is positioned within the recess in a second configuration, the second edge is magnetically engaged with the recessed ledge and the resilient protrusion is contained within the recess.

In another aspect, a reconfigurable support is provided, the reconfigurable support includes (i) a first side comprising a first edge that is substantially planar, the first edge configured for magnetic engagement with a recessed ledge of a recess formed in a bottom surface of a housing, the recess comprising a perimeter, and the recessed ledge extending about at least a portion of the perimeter of the recess, and (ii) a second side opposite the first side and configured for magnetic engagement with the recessed ledge, the second side comprising a second edge that is substantially planar and parallel to the first edge, the second edge surrounding a resilient protrusion that extends outward from a plane of the second edge, wherein (a) when the reconfigurable support is positioned within the recess in a first configuration, the first edge is magnetically engaged with the recessed ledge and the resilient protrusion extends outward from the bottom surface of the housing, and (b) when the reconfigurable support is positioned within the recess in a second configuration, the second edge is magnetically engaged with the recessed ledge and the resilient protrusion is contained within the recess.

In yet another aspect, a playback device is provided that includes (i) at least one transducer, (ii) a housing configured for enclosing, at least in part, the at least one transducer, and (iii) a reconfigurable support. The housing includes (i) a bottom surface, and (ii) a recess formed in the bottom surface of the housing, the recess comprising a perimeter and a recessed ledge extending about at least a portion of the perimeter of the recess. The reconfigurable support includes (i) a first side comprising a first edge that is substantially planar, and (ii) a second side opposite the first side comprising a second edge that is substantially planar and parallel to the first edge, the second edge surrounding a resilient protrusion that extends outward from a plane of the second edge, wherein (a) when the reconfigurable support is positioned within the recess in a first configuration, the first edge is magnetically engaged with the recessed ledge and the resilient protrusion extends outward from the bottom surface of the housing, and (b) when the reconfigurable support is positioned within the recess in a second configuration, the second edge is magnetically engaged with the recessed ledge and the resilient protrusion is contained within the recess.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one clement or function is a necessary result of another function or element. For the sake of brevity, functions are generally described as being based on another function when a functional link exists; however, such disclosure should be understood as disclosing either type of functional relationship.

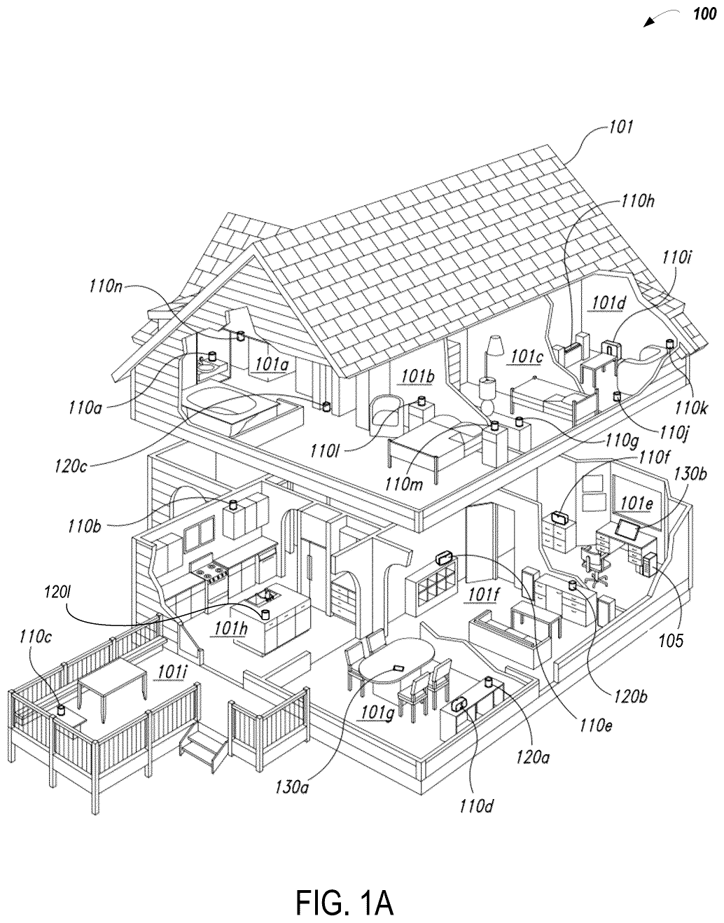

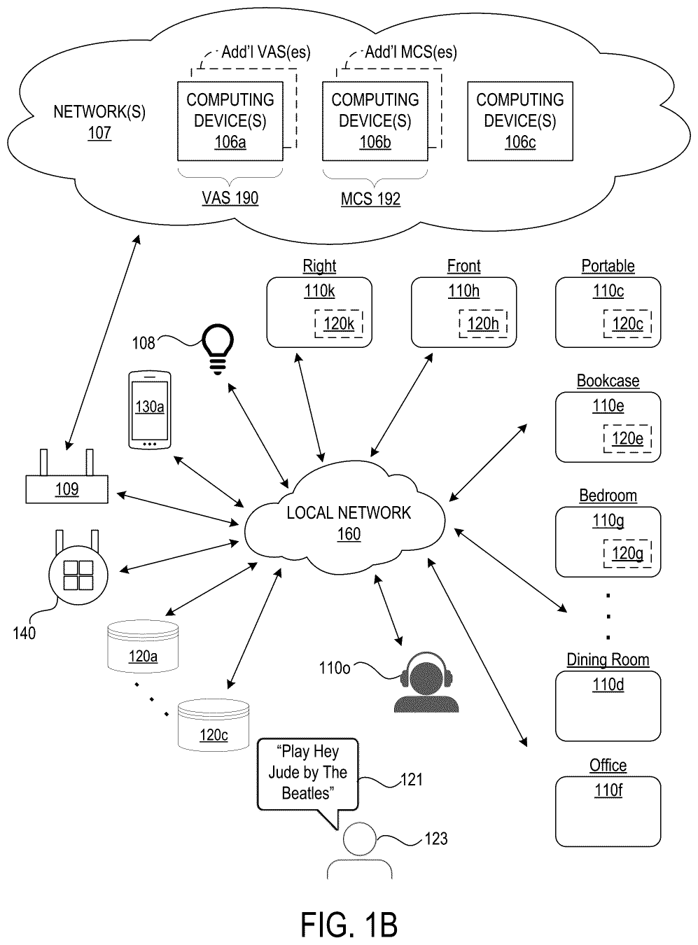

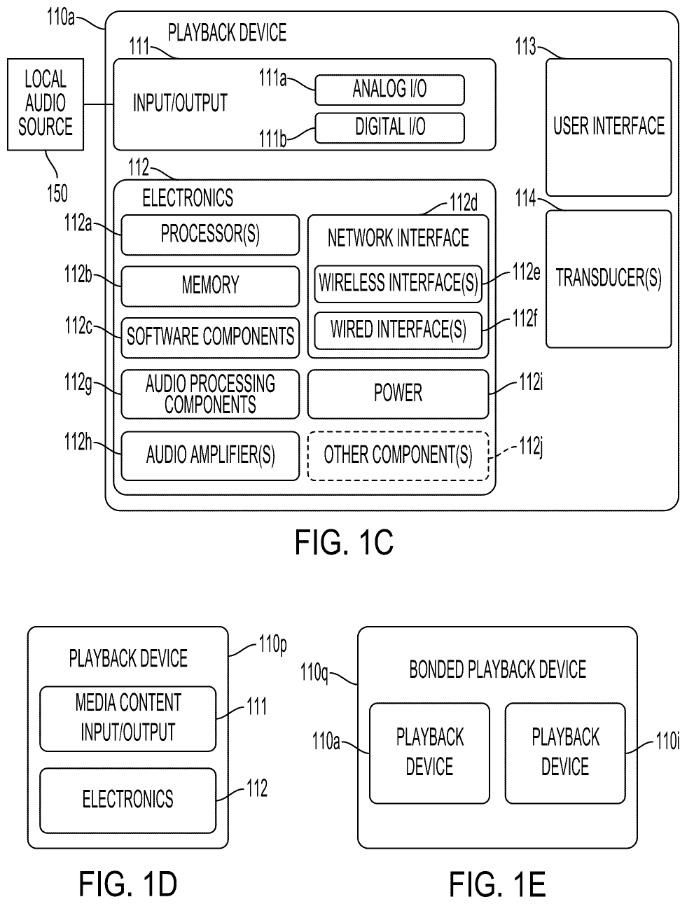

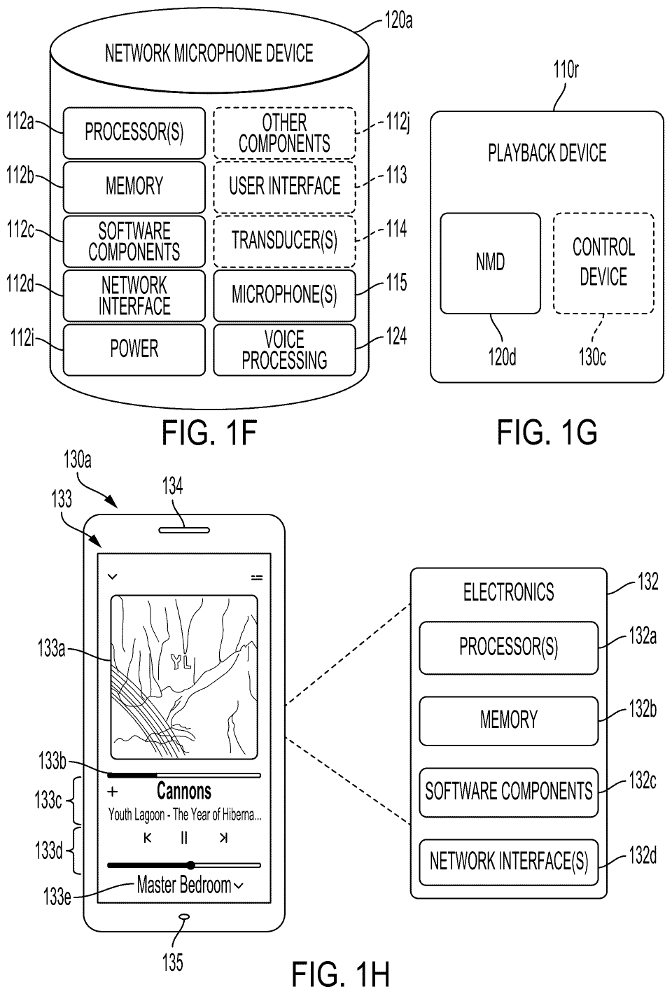

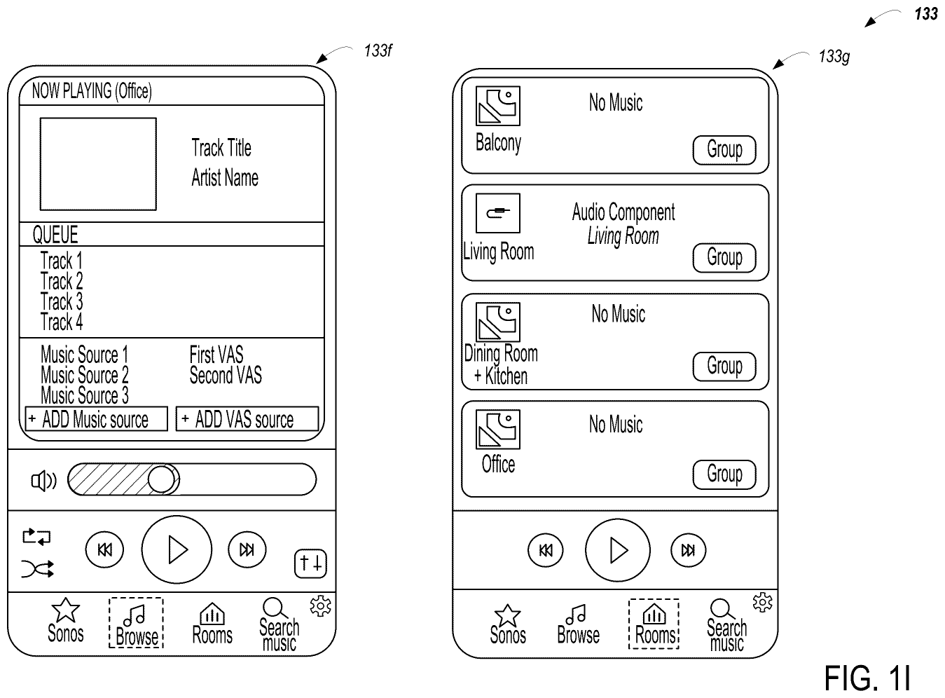

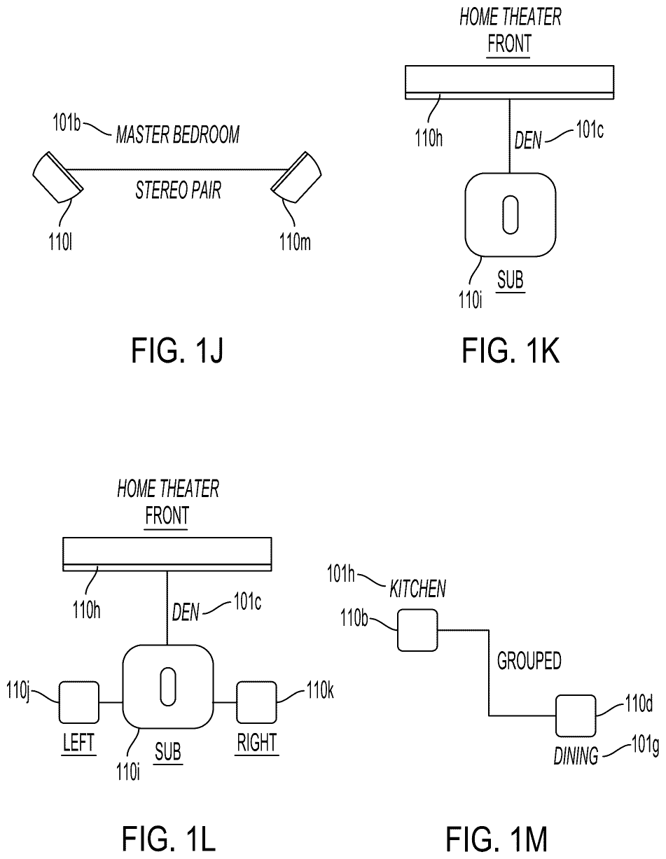

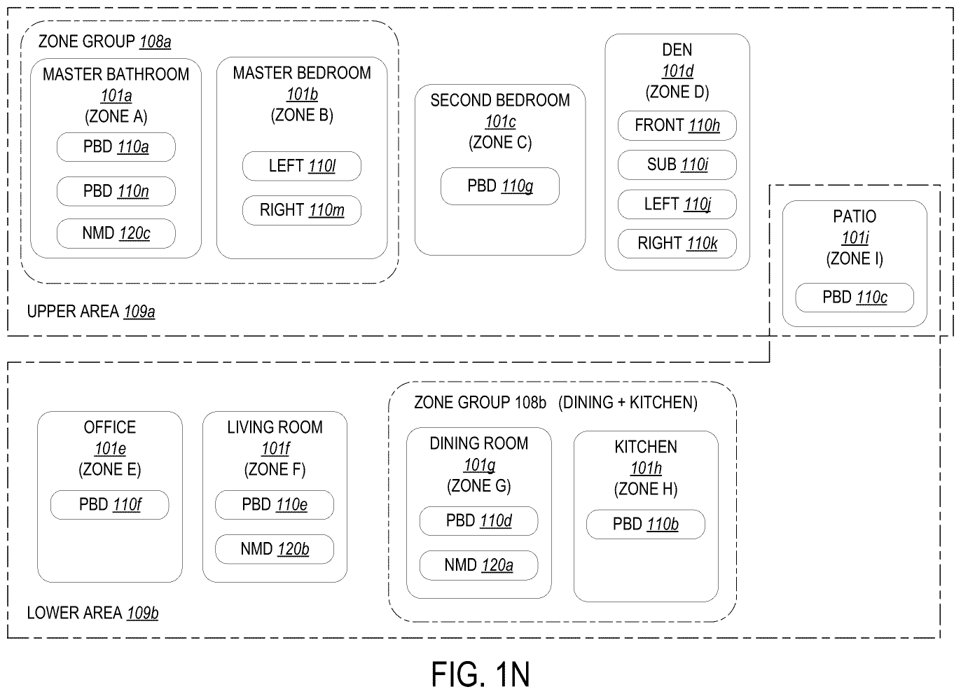

In the figures, identical reference numbers identify generally similar, and/or identical, elements. To facilitate the discussion of any particular element, the most significant digit or digits of a reference number refers to the figure in which that element is first introduced. For example, element 110a is first introduced and discussed with reference to FIG. 1A. Many of the details, dimensions, angles and other features shown in the figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

a. Suitable Media Playback System

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-1N.

In the illustrated embodiment of FIG. 1A, the environment 101 comprises a household having several rooms, spaces, and/or playback zones, including (clockwise from upper left) a Master Bathroom 101a, a Master Bedroom 101b, a Second Bedroom 101c, a Family Room or Den 101d, an Office 101e, a Living Room 101f, a Dining Room 101g, a Kitchen 101h, and an outdoor Patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added and/or removed to form, for example, the configuration shown in FIG. 1A. Each zone may be given a name according to a different room or space such as the Office 101e, Master Bathroom 101a, Master Bedroom 101b, the Second Bedroom 101c, Kitchen 101h, Dining Room 101g, Living Room 101f, and/or the Patio 101i. In some aspects, a single playback zone may include multiple rooms or spaces. In certain aspects, a single room or space may include multiple playback zones.

In the illustrated embodiment of FIG. 1A,, the Master Bathroom 101a, the Second Bedroom 101c, the Office 101e, the Living Room 101f, the Dining Room 101g, the Kitchen 101h, and the outdoor Patio 101i each include one playback device 110, and the Master Bedroom 101b and the Den 101d include a plurality of playback devices 110. In the Master Bedroom 101b, the playback devices 110l and 110m may be configured, for example, to play back audio content in synchrony as individual ones of playback devices 110, as a bonded playback zone, as a consolidated playback device, and/or any combination thereof. Similarly, in the Den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108 (FIG. 1B), a smart thermostat 140 (FIG. 1B), and a local computing device 105 (FIG. 1A). Numerous other examples of local network devices (not shown) are also possible, such as doorbells, cameras, smoke alarms, televisions, gaming consoles, garage door openers, etc. In embodiments described below, one or more of the various playback devices 110 may be configured as portable playback devices, while others may be configured as stationary playback devices. For example, the headphones 110o (FIG. 1B) are a portable playback device, while the playback device 110e on the bookcase may be a stationary device. As another example, the playback device 110c on the Patio 101i may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WIFI network, a Z-Wave network, etc.) and/or one or more personal area networks (PANs) (e.g. a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, 6 GHz, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to any number of different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCER®, or other voice assistant providers. In some implementations, MCSes may be operated by one or more of SPOTIFY®, PANDORA®, AMAZON MUSIC®, YOUTUBE MUSIC, APPLE MUSIC®, GOOGLE PLAY®, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WIFI network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, audio content sources may be regularly added and/or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device(s) 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to detect sound, including voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 120l (FIG. 1A) may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 1201 may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio 101i may be named “Portable” because it is battery-powered and/or readily transportable to different areas of the environment 101. Other naming conventions are possible.

As discussed above, an NMD may detect and process sound from its environment, including audio output played by itself, played by other devices in the environment 101, and/or sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word (also referred to herein as an activation word) associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in tum causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Pat. No. 10,499,146, issued Nov. 13, 2019 and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude” performed by The Beatles. After these determinations, the VAS 190 may transmit a command to a particular MCS 192 to retrieve content (i.e., the song “Hey Jude” by The Beatles), and that MCS 192, in turn, provides (e.g., streams) this content directly to the NIPS 100 or indirectly via the VAS 190. In some implementations, the VAS 190 may transmit to the NIPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Pat. No. 10,499,146.

In certain implementations, an NMD may be assigned to, or otherwise associated with, a designated or default playback device that may not include an NMD. For example, the Island NMD 120l in the Kitchen 101h (FIG. 1A) may be assigned to the Dining Room playback device 110d, which is in relatively close proximity to the Island NMD 120l. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Pat. No. 10,499,146.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication protocol. In certain embodiments, the analog I/O 1101a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1B), amplify the received audio, and output the amplified audio for playback via one or more of the transducers 114. In some embodiments, the playback device 110a optionally includes one or more microphones (e.g., a single microphone, a plurality of microphones, a microphone array) (hereinafter referred to as “the microphones”). In certain embodiments, for example, the playback device 110a having one or more of the optional microphones can operate as an NMD configured to receive voice input from a user and correspondingly perform one or more operations based on the received voice input, which will be discussed in more detail further below with respect to FIGS. 1F and 1G.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices and/or zones can be found, for example, in U.S. Pat. No. 8,234,395 entitled “System and method for synchronizing operations among a plurality of independently clocked digital data processing devices,” which is herein incorporated by reference in its entirety.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WIFI, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more light components (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” “SUB,” “BEAM,” “ARC,” “MOVE,” “ERA 100,” “ERA 300,” and “ROAM,” among others. Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more of the playback devices 110 may comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device may omit a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

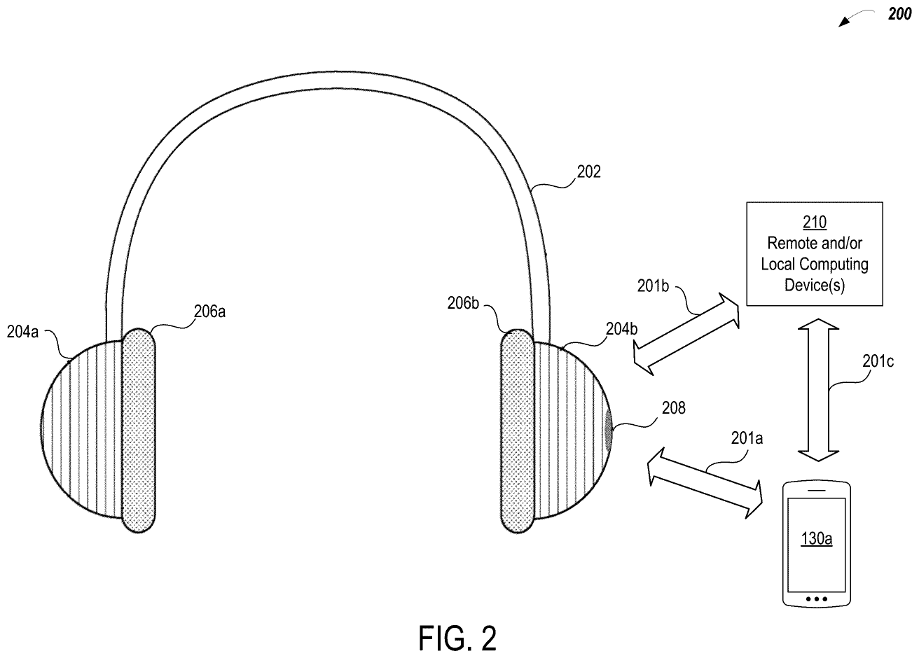

In some embodiments, one or more of the playback devices 110 may take the form of a wired and/or wireless headphone device (e.g., over-ear headphones, on-ear headphones, in-car earphones, etc.). For instance, FIG. 2 shows an example headset assembly 200 (“headset 200”) for such an implementation of one of the playback devices 110. As shown, the headset 200 includes a headband 202 that couples a first earcup 204a to a second earcup 204b. Each of the earcups 204a and 204b may house any portion of the electronic components in the playback device 110, such as one or more speakers. Further, one or both of the earcups 204a and 204b may include a user interface for controlling audio playback, volume level, and other functions. The user interface may include any of a variety of control elements such as a physical button 208, a slider (not shown), a knob (not shown), and/or a touch control surface (not shown). As shown in FIG. 2, the headset 200 may further include car cushions 206a and 206b that are coupled to earcups 204a and 204b, respectively. The car cushions 206a and 206b may provide a soft barrier between the head of a user and the earcups 204a and 204b, respectively, to improve user comfort and/or provide acoustic isolation from the ambient (e.g., passive noise reduction (PNR)).

As described in greater detail below, the electronic components of a playback device may include one or more network interface components (not shown in FIG. 2) to facilitate wireless communication over one more communication links. For instance, a playback device may communicate over a first communication link 201a (e.g., a BLUETOOTH link) with one of the control devices 130, such as the control device 130a, and/or over a second communication link 201b (e.g., a WIFI or cellular link) with one or more other computing devices 210 (e.g., a network router and/or a remote server). As another possibility, a playback device may communicate over multiple communication links, such as the first communication link 201a with the control device 130a and a third communication link 201c (e.g., a WIFI or cellular link) between the control device 130a and the one or more other computing devices 210. Thus, the control device 130a may function as an intermediary between the playback device and the one or more other computing devices 210, in some embodiments.

In some instances, the headphone device may take the form of a hearable device. Hearable devices may include those headphone devices (including car-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone device. Wearable devices may include those devices configured to be worn about a portion of a user (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMDs)

FIG. IF is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. IC. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. 1F). The microphones 115 are configured to detect sound (i.e., acoustic waves) in the environment of the playback device 110r, which may then be provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Pat. No. 10,499,146.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The NMD 120a may use the microphone data (or transmit the microphone data to another device) for calibrating the audio characteristics of one or more playback devices 110 in the MPS 100. As another example, one or more of the playback devices 110, NMDs 120, and/or control devices 130 of the MPS 100 may transmit audio tones (e.g., ultrasonic tones, infrasonic tones) that may be detectable by the microphones 115 of other devices, and which may convey information such as a proximity and/or identity of the transmitting device, a media playback system command, etc. As yet another example, the voice processing components 124 may receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Controller Devices

FIG. 1H is a partially schematic diagram of one example of the control device 130a (FIGS. 1A and 1B). As used herein, the term “control device” can be used interchangeably with “controller,” “controller device,” or “control system.” Among other features, the control device 130a is configured to receive user input related to the MPS 100 and, in response, cause one or more devices in the MPS 100 to perform an action(s) and/or an operation(s) corresponding to the user input. In the illustrated embodiment, the control device 130a comprises a smartphone (e.g., an iPhone™. an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processor(s) 132a”), a memory 132b, software components 132c, and a network interface 132d. The processor(s) 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among other changes. Additional description of zones and groups can be found below with respect to FIGS. 1J through 1N.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133c. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system. FIG. 1I shows two additional example user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1J, 1K, 1L, 1M, and 1N show example configurations of playback devices in zones and zone groups. Referring first to FIG. 1N, in one example, a single playback device may belong to a zone. For example, the playback device 110g in the Second Bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities), as will be described in more detail further below. In other implementations, multiple playback devices may be merged to form a single zone. As one example, the playback device 110a can be bonded to the playback device 110n and the NMD 120c to form Zone A. As another example, the playback device 110h (e.g., a front playback device) may be merged with the playback device 110i (e.g., a subwoofer), and the playback devices 110j and 110k (e.g., left and right surround speakers, respectively) to form a single Zone D. In yet other implementations, one or more playback zones can be merged to form a zone group (which may also be referred to herein as a merged group). As one example, the playback zones Zone A and Zone B can be merged to form Zone Group 108a. As another example, the playback zones Zone G and Zone H can be merged to form Zone Group 108b. The merged playback zones Zone G and Zone H may not be specifically assigned different playback responsibilities. That is, the merged playback zones Zone G and Zone H may, aside from playing audio content in synchrony, cach play audio content as they would if they were not merged and operating as independent zones.

Each zone in the MPS 100 may be represented for control as a single user interface (UI) entity. For example, Zone A may be represented as a single entity named Master Bathroom. Zone B may be represented as a single entity named Master Bedroom. Zone C may be represented as a single entity named Second Bedroom.

In some implementations, as mentioned above playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB playback device 110i can be configured to render low frequencies. When unbonded, however, the Front device 110h can be configured to render a full range of frequencies. As another example, FIG. 1L shows the Front and SUB playback devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 1N).

In other implementations, playback devices that are merged may not have assigned playback responsibilities and may cach render the full range of audio content of which the respective playback device is capable. Nevertheless, merged devices may be represented as a single UI entity (i.e., a zone, as discussed above). For instance, the playback devices 110a and 110n in the Master Bathroom have the single UI entity of Zone A. In one embodiment, the playback devices 110a and 110n may each output the full range of audio content of which each respective playback devices 110a and 110n is capable, in synchrony.

In some embodiments, an NMD may be bonded or merged with one or more other devices so as to form a zone. As one example, the NMD 120c may be merged with the playback devices 110a and 110n to form Zone A. As another example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. Pat. No. 10,499,146.

As mentioned above, in some implementations, zones of individual, bonded, and/or merged devices may be grouped to form a zone group. For example, referring to FIG. 1N, Zone A may be grouped with Zone B to form a zone group 108a that includes the two zones, and Zone G may be grouped with Zone H to form the zone group 108b. However, other zone groupings are also possible. For example, Zone A may be grouped with one or more other Zones C-I. The Zones A-I may be grouped and ungrouped in numerous ways. For example, three, four, five, or more (e.g., all) of the Zones A-I may be grouped at any given time. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zone groups in an environment may be named by according to a name of a zone within the group or a combination of the names of the zones within a zone group. For example, Zone Group 108b can be assigned a name such as “Dining +Kitchen”, as shown in FIG. 1N. In other implementations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the Second Bedroom 101c may indicate (i) that the playback device 110g is the only playback device of the Zone C and (ii) that Zone C is not in a zone group. Identifiers associated with the Den 101d may indicate that the Den 101d is not grouped with other zones but includes bonded playback devices 110h-110k. Identifiers associated with the Dining Room 101g may indicate that the Dining Room 101g is part of the Dining+Kitchen Zone Group 108b and that devices 110d and 110b (Kitchen 101h) are grouped (FIGS. 1M, 1N). Identifiers associated with the Kitchen 101h may indicate the same or similar information by virtue of the Kitchen 101h being part of the Dining +Kitchen Zone Group 108b. Other example zone variables and identifiers are described below.

In yet another example, the MPS 100 may include variables or identifiers representing other associations of zones and zone groups, such as identifiers associated with Areas, as shown in FIG. 1N. An area may involve a cluster of zone groups and/or zones not within a zone group. For instance, FIG. 1N shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, issued Jul. 14, 2020, and titled “Room Association Based on Name,” and U.S. Pat. No. 8,483,853, filed Sep. 11, 2007, issued Jul. 9, 2013, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

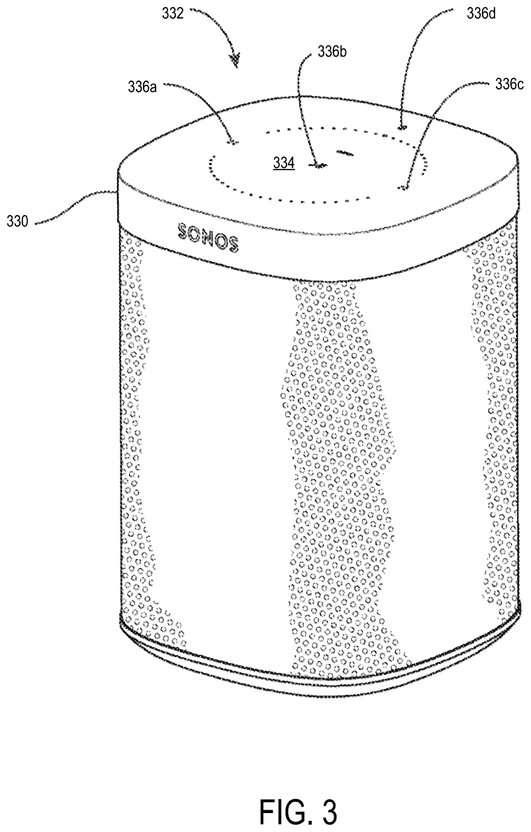

FIG. 3 shows an example housing 330 of a playback device (e.g., one of the playback devices 110 discussed above) that includes a user interface in the form of a control area 332 at a top portion 334 of the housing 330. The control area 332 includes buttons 336a, 336b, and 336c for controlling audio playback, volume level, and other functions. The control area 332 also includes a button 336d for toggling one or more microphones (not visible in FIG. 3) of the playback device 110 to either an on state or an off state. The control area 332 is at least partially surrounded by apertures formed in the top portion 334 of the housing 330 through which the microphones receive the sound in the environment of the playback device. The microphones may be arranged in various positions along and/or within the top portion 334 or other areas of the housing 330 so as to detect sound from one or more directions relative to the playback device.

f. Audio Content

Audio content may be any type of audio content now known or later developed. For example, in some embodiments, the audio content includes any one or more of: (i) streaming music or other audio obtained from a streaming media service, such as Spotify, Pandora, or other streaming media services; (ii) streaming music or other audio from a local music library, such as a music library stored on a user's laptop computer, desktop computer, smartphone, tablet, home server, or other computing device now known or later developed; (iii) audio content associated with video content, such as audio associated with a television program or movie received from any of a television, set-top box, Digital Video Recorder, Digital Video Disc player, streaming video service, or any other source of audio-visual media content now known or later developed; (iv) text-to-speech or other audible content from a voice assistant service (VAS), such as Amazon Alexa or other VAS services now known or later developed; (v) audio content from a doorbell or intercom system such as Nest, Ring, or other doorbells or intercom systems now known or later developed; and/or (vi) audio content from a telephone, video phone, video/teleconferencing system or other application configured to allow users to communicate with each other via audio and/or video.

Audio content that can be played by a playback device as described herein, including any of the aforementioned types of audio content, may also be referred to herein as media content. A source from which the media content is obtained may be referred to herein as a media content source.

In operation, a “sourcing” playback device obtains any of the aforementioned types of audio content from an audio source via an interface on the playback device, e.g., one of the sourcing playback device's network interfaces, a “line-in” analog interface, a digital audio interface, or any other interface suitable for receiving audio content in digital or analog format now known or later developed.

An audio source is any system, device, or application that generates, provides, or otherwise makes available any of the aforementioned audio content to a playback device. For example, in some embodiments, an audio source includes any one or more of a streaming media (audio, video) service, digital media server or other computing system, VAS service, television, cable set-top-box, streaming media player (e.g., AppleTV, Roku, gaming console), CD/DVD player, doorbell, intercom, telephone, tablet, or any other source of digital audio content.

A playback device that receives or otherwise obtains audio content from an audio source for playback and/or distribution to other playback devices may be referred to herein as the “sourcing” playback device, “master” playback device, or “group coordinator.” One function of the “sourcing” playback device is to process received audio content for playback and/or distribution to other playback devices. In some embodiments, the sourcing playback device transmits the processed audio content to all the playback devices that are configured to play the audio content. In some embodiments, the sourcing playback device transmits the processed audio content to a multicast network address, and all the other playback devices configured to play the audio content receive the audio content via that multicast address. In some embodiments, the sourcing playback device alternatively transmits the processed audio content to cach unicast network address of each other playback device configured to play the audio content, and cach of the other playback devices configured to play the audio content receive the audio content via its unicast address.

### III. Example Reconfigurable Supports and Associated Housings for Device(s)

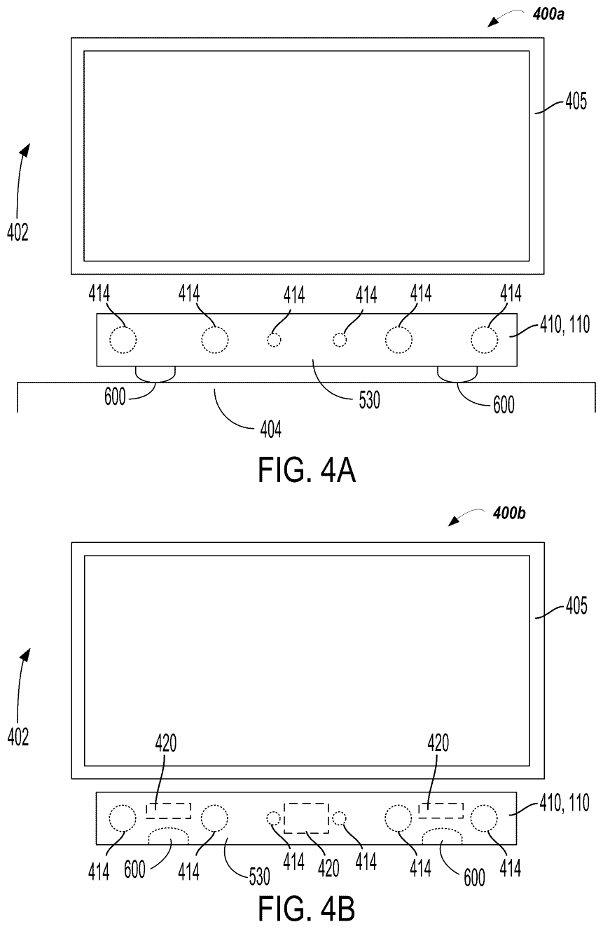

Turning now to FIGS. 4A and 4B, example entertainment environments 400a, 400b are illustrated, wherein a playback device 410 is positioned relative to a display 405. The playback device 410 may be or include like elements to the playback device(s) 110, discussed above and, for example, may include one or more transducers 414, which may include like or similar elements to the transducer(s) 114, and any other transducer(s), discussed above with respect to FIGS. 1-3. Each of the transducers 114 of the playback device 410 are housed, at least in part, by a housing 530 of the electronic device.

As illustrated in FIG. 4A, in some examples, the playback device 410 can be positioned on a surface 404, within the entertainment environment 400a, upon which the playback device 410 rests during media playback. The surface 404 may be part of an entertainment center, a table, a desk, a credenza, a shelf, a shelving unit, or combinations thereof, among other known surfaces suitable for placement of a playback device 410. In some such examples and as illustrated, when resting on the surface 404, reconfigurable support(s) 600 of the playback device may be configured for positioning the playback device 410 in an elevated position, with respect to the surface 404. Such a position, with the reconfigurable support(s) 600 protruding from the housing 530, may be referred to herein as a first or “surface” configuration for the reconfigurable support(s) 600.

Alternatively, as illustrated by the entertainment environment 400b of FIG. 4B, the playback device 410 may be mounted within the entertainment environment 400b. For instance, the playback device 410 may be mounted to a wall 402 of the entertainment environment 400, via mounting features 420, which may include, but are not limited to including, fasteners, proprietary mounting hardware, standards based mounting hardware (e.g., Video Electronics Standards Association (VESA) mounting hardware), among other known mounting systems or apparatus. Alternatively, in some examples, the playback device 410 may be mounted to another device (e.g., the display 405, a mount for the display 405), while still being free from resting on a surface (e.g., the surface 404).

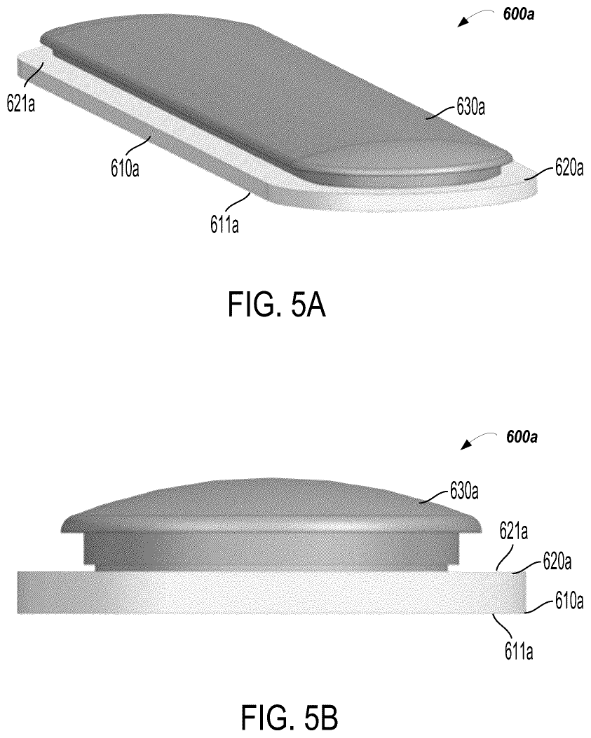

As illustrated in FIG. 4B, it may appear that the reconfigurable support(s) 600 are not present or have been removed; however, in some examples and as will be clearer when considered in view of FIGS. 5-10, when the reconfigurable support(s) 600 are in a second or “mounted” configuration, most or all of the physical body of the reconfigurable support(s) 600 will reside within a recess in a surface of the playback device 410 (e.g., a recess in the housing 530). As signified by the dotted lines, similar to the transducer(s) 414, when the reconfigurable support(s) 600 are in the second or “mounted” position, the reconfigurable support(s) 600 may reside at least in part, if not in full, within the housing 530 of the playback device 410.

FIGS. 5A and 5B illustrate a first example reconfigurable support 600a, shown in a perspective view in FIG. 5A and a side view in FIG. 5B. As illustrated, the reconfigurable support 600a includes a first side 610a, which includes a first edge 611a which, as shown, may be substantially planar. The reconfigurable support 600a further includes a second side 620a, arranged opposite of the first side 610a, which includes a second edge 621a that is substantially planar and parallel to the first edge 611a. Further, the reconfigurable support 600a includes a resilient protrusion 630a, which may be surrounded by the second edge 621a and protrude outward from the plane defined by the second edge 621a.

As discussed above, the resilient protrusion 630a may be configured to elevate the playback device 410, when the reconfigurable support 600a is positioned in a “surface” or first configuration for the reconfigurable support 600a. In some examples, the resilient protrusion 630a is formed of a material that can absorb energy and prevent slipping, vibration, or other movement caused by functions of the playback device 410. Such materials that may be utilized to form the resilient protrusion 630a may include, but are not limited to including, a rubber material, silicon, among other known resilient materials.

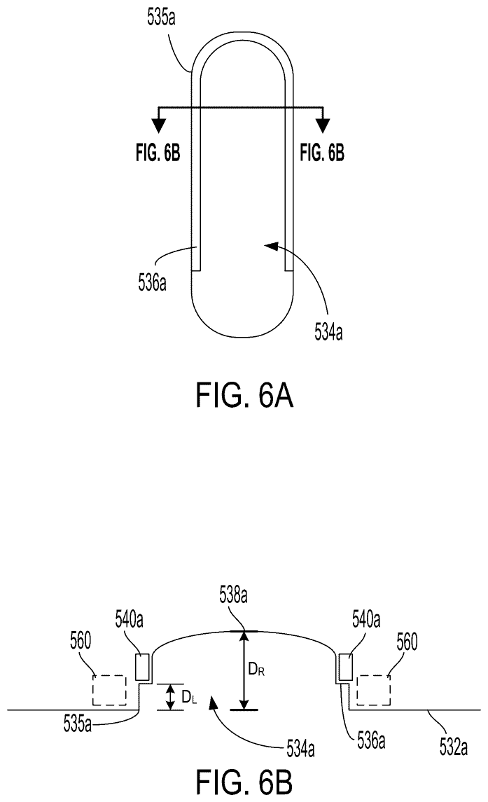

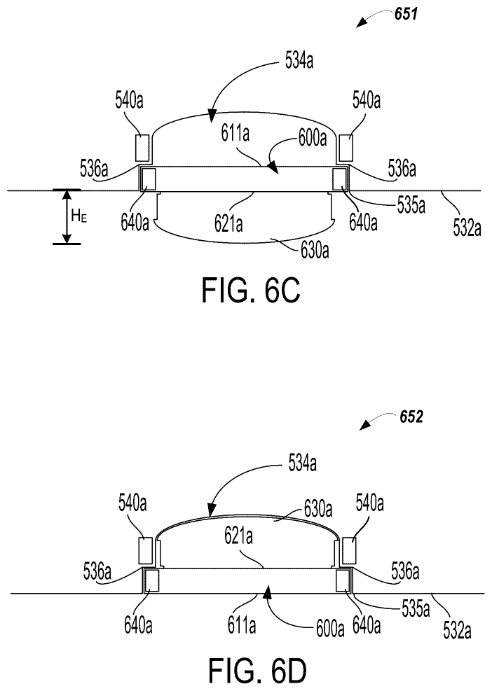

Turning now to FIGS. 6A-6D and with continued reference to FIGS. 4A-5B, several views of an example recess formed in a portion of a housing of a playback device—such as the playback device 410—are shown. As generally depicted in FIGS. 6A-6D, a recess 534a extends inward into the housing 530a, from a bottom surface 532a of the housing 530a. While illustrated and described as a recess extending into the housing from the bottom surface 532a, it is certainly contemplated that another recess or another embodiment of the recess 534 may extend into the housing from another surface, such as, but not limited to, a side surface of the playback device 410.

Beginning with FIG. 6A, a top-down view of the recess 534a is shown. The recess 534a may define or include a perimeter 535a and a recessed ledge 536a, the recessed ledge 536a extending about at least a portion of the perimeter 535a of the recess 534a. FIG. 6A also indicates the location of the cross-sectional view of the recess 534a that is shown in FIG. 6B, and which better illustrates the relationship of the recessed ledge 536a to the depth of the recess 534a. As shown in FIG. 6B, the recess has a first or maximum depth, defined as a recess depth (D_{R}), which may extend between a plane defined by the bottom surface 532a of the housing and the deepest point 538a of the recess 534a. Further, the recessed ledge 536a extends radially inward from the perimeter 535a of the recess 534a and has a ledge depth (D_{L}), which extends from the plane defined by the bottom surface 532a of the housing to a plane defined by the recessed ledge 536a. As shown in FIG. 6B, D_{L} may be less than D_{R}.

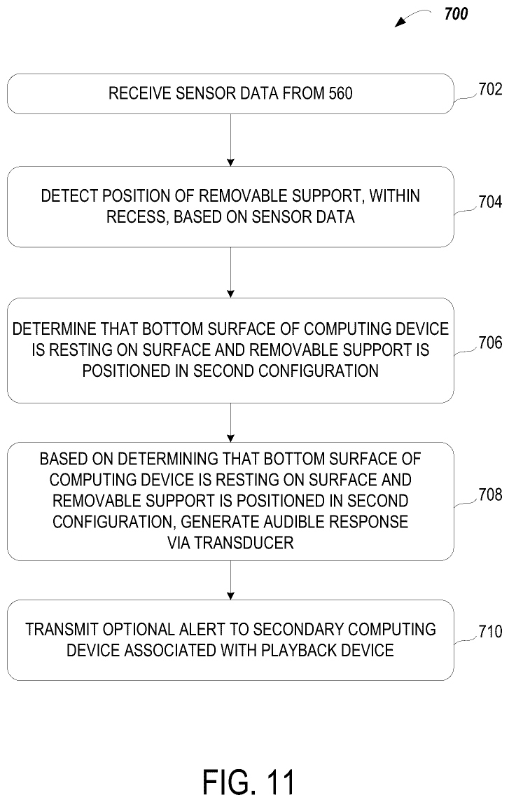

As illustrated in FIGS. 6B-6D, the playback device 410 and/or the housing thereof may include one or more sensors 560 and one or more magnetic connector(s) 540a. The sensor(s) 560 may be utilized by the playback device 410 to determine positioning of one or more reconfigurable supports 600, whether in a first configuration, a second configuration, or other configurations for the reconfigurable supports 600. The sensor(s) 560 and operations thereof are discussed in greater detail, below, with respect to FIG. 11. Further, the magnetic connector(s) 540a are positioned proximate to one or more of the perimeter 535a, the recessed ledge 536a, or combinations thereof and are configured for magnetically engaging with the reconfigurable support 600a for positioning the reconfigurable support 600a in at least the first and second configurations.

To that end, FIG. 6C illustrates the recess 534a, wherein the reconfigurable support 600a is magnetically engaged with the housing. Specifically, the first edge 611a of the reconfigurable support 600a abuts the recessed ledge 536a, in a first configuration 651, which may be a surface configuration. In some examples, as illustrated, the reconfigurable support 600a is magnetically engaged with the housing via magnetic connection between the magnetic connector 540a, which may be referred to as a first magnetic connector, and a second magnetic connector 640a that forms part of the reconfigurable support 600a. For example, the first magnetic connector 540a may take the form of one or more magnets positioned within the housing (e.g., along the recessed ledge 536a), and the second magnetic connector may take the form of a metallic material (e.g., steel) that is magnetically attracted to the first magnetic connector 540a. In some embodiments, the reconfigurable support 600a may be formed, in part, from the metallic material. Other examples are also possible.

When the reconfigurable support 600a is positioned in the first configuration 561, the resilient protrusion 630a extends outward from the bottom surface 532a of the housing. When the reconfigurable support 600a is positioned in the first configuration 561 and the playback device 410, for example, rests on the surface 404, the reconfigurable support 600a is configured to support the playback device 410 and elevate the bottom surface 532a of the playback device 410 above the surface 404. In such examples, the bottom surface 532a may be elevated above the surface 404 by a height (H_{E}), which may be configured for providing enough separation between the surface 404 and the bottom of the electronic device for proper ventilation and cooling. In such examples, H_{E} may be configured such that one or more of a fan, a heat sink, a vent, or combinations thereof, of the playback device 410 has enough room underneath the device for proper air and heat ingress and egress, for proper thermal performance for the playback device 410. Further still, H_{E} may be configured such that an acoustic performance or fidelity for the device, when it is an audio playback device, is not compromised by a transducer 414 resting too close to the surface 404. In some examples, H_{E} may be in a range of about 10 millimeters (mm.) to about 100 mm.

FIG. 6D is another cross-sectional view of the recess 534a and the reconfigurable support 600a; however, in the illustration of FIG. 6D, the reconfigurable support 600a is positioned within the recess 534a in a second position 652, which may be a position configured for stowing the reconfigurable support 600a, when the playback device 410 is to be mounted (e.g., the example of FIG. 4B). In such examples, the second edge 621a of the second side 620a of the reconfigurable support 600a is magnetically engaged with the recessed ledge 536a, via, for example, the first and second magnetic connectors 540a, 640a, and the resilient protrusion 630a is substantially contained within the recess 534a. In some such examples, when the reconfigurable support 600a is positioned in the second configuration 652, the first side 610a and/or the first edge 611a, thereof, is substantially flush with the bottom surface 532a of the housing. Thus, in the second configuration 652, as illustrated in FIG. 6D, the reconfigurable support 600a may be substantially unnoticeable by a user and/or may not substantially protrude from the bottom surface 532a. Accordingly, utilizing the second configuration 652 in a mounted-device scenario may obscure view of the reconfigurable support 600a, may avoid any unwanted protrusions touched or seen by the user or other beings in the vicinity of the playback device 410, and/or the second configuration may stow away the reconfigurable support 600a safely and with the playback device 410. Beneficially, this arrangement allows a user to easily switch to the first configuration 651, for a surface positioned configuration for the playback device 410, if he/she/they desire such a configuration for future use of the playback device 410.

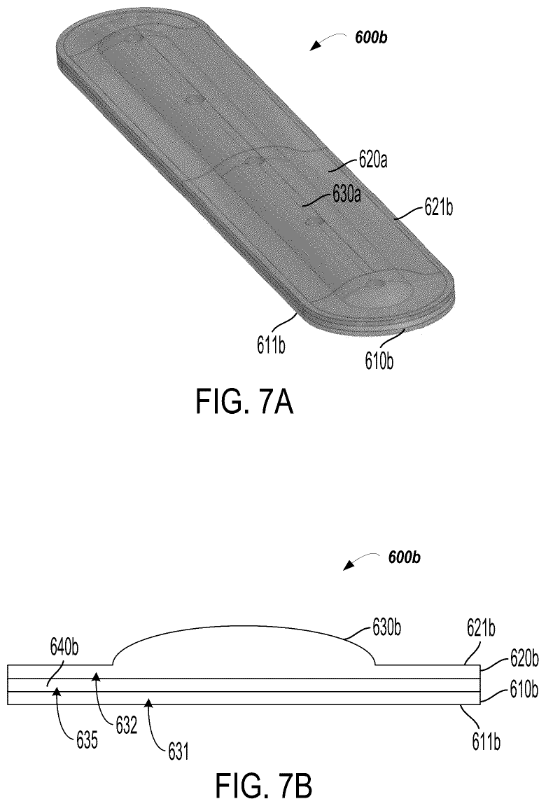

FIGS. 7A and 7B illustrate a second example reconfigurable support 600b, shown in a perspective view in FIG. 7A and a side view in FIG. 7B. As illustrated, the example reconfigurable support 600b includes like or similar features to those of the reconfigurable support 600a and, thus, are labeled with similar or common reference numerals.

For example, the reconfigurable support 600b includes a first side 610b, which includes a first edge 611b which, as shown, may be substantially planar. The reconfigurable support 600b further includes a second side 620b, arranged opposite of the first side 610b, which includes a second edge 621b that is substantially planar and parallel to the first edge 611b. Further, the reconfigurable support 600b includes a resilient protrusion 630b, which may be surrounded by the second edge 621b and protrude outward from the plane defined by the second edge 621b.

As discussed above, the resilient protrusion 630b may be configured to elevate the playback device 410, when the reconfigurable support 600b is positioned in a “surface” or first configuration for the reconfigurable support 600b. Such materials that may be utilized to form the resilient protrusion 630b may include, but are not limited to including, a rubber material, silicon, among other known resilient materials.

In some examples and as best illustrated in FIG. 7B, the reconfigurable support 600b may include a resilient first layer 631, which forms the first side 610b and/or defines the first edge 611b thereof. Opposite the resilient first layer 631, the reconfigurable support 600b may further include a resilient second layer 632, which forms the second side 620b and defines the second edge 621b. In some such examples, the resilient protrusion 630b is integrally formed with the resilient second layer 632. Further, the reconfigurable support 600b may include a rigid layer 635 that is affixed to and positioned in between the resilient first layer 631 and the resilient second layer 632. In some further examples, the rigid layer 635 may include or embody a second magnetic connector 640b, which, as discussed below, is utilized to magnetically engage the reconfigurable support 600b with the housing 530b. For instance, the rigid layer 635 may be formed from steel or a similar metallic material that exhibits magnetic attraction to a magnet (e.g., a set of one or more magnets within the housing 530 of the playback device 410).

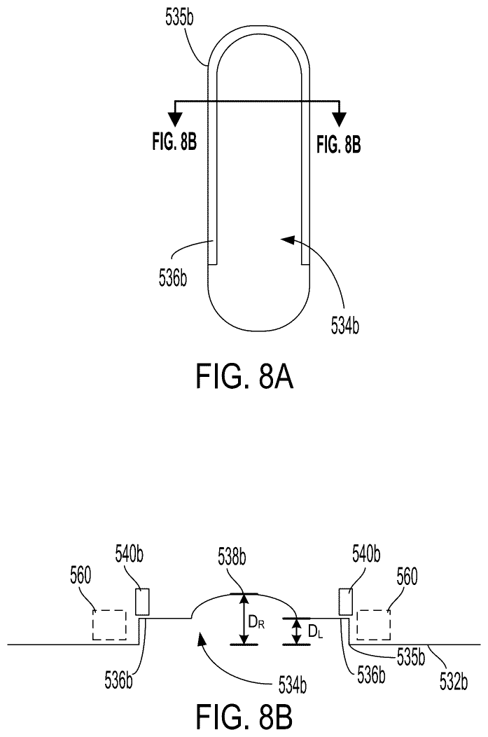

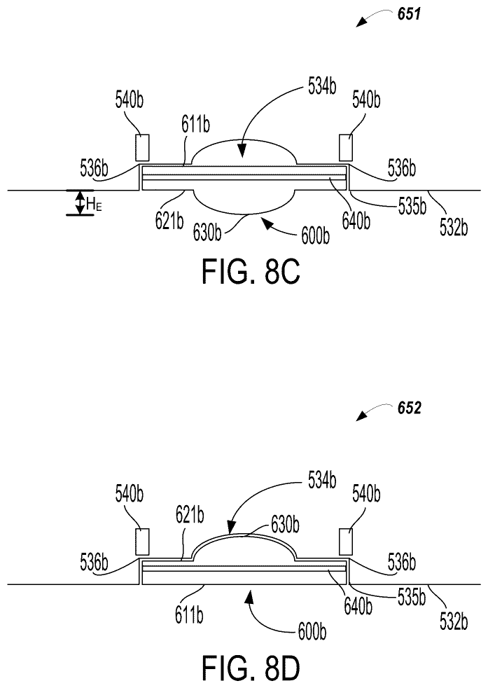

Turning now to FIGS. 8A-8C and with continued reference to FIGS. 7A-7B, several views of an example recess formed in a portion of a housing of a playback device—such as the playback device 410—are shown. As generally depicted in FIGS. 8A-8D, a recess 534b extends inward into the housing from a bottom surface 532b of the housing. While illustrated and described as a recess extending into the housing from the bottom surface 532b, it is certainly contemplated that another recess or another embodiment of the recess 534b may extend into the housing from another surface, such as, but not limited to, a side surface of the playback device 410.

Beginning with FIG. 8A, a top-down view of the recess 534b is shown. The recess 534b may define or include a perimeter 535b and a recessed ledge 536b, the recessed ledge 536b extending about at least a portion of the perimeter 535b of the recess 534b. FIG. 8A also indicates the location of the cross-sectional view of the recess 534b that is shown in FIG. 8B, and which better illustrates the relationship of the recessed ledge 536b to the depth of the recess 534b. As shown in FIG. 8B, the recess has a first or maximum depth, defined as a recess depth (D_{R}), which may extend between a plane defined by the bottom surface 532b of the housing and the deepest point 538b of the recess 534b. Further, the recessed ledge 536b extends radially inward from the perimeter 535b of the recess 534b and has a ledge depth (DL.), which extends from the plane defined by the bottom surface 532b to a plane defined by the recessed ledge 536b. As shown in FIG. 8B, D_{L} may be less than D_{R}.

As illustrated in FIGS. 8B-8D, the playback device 410 and/or the housing thereof may include one or more sensors 560 and one or more magnetic connector(s) 540b. The sensor 560 may be utilized by the playback device 410 to determine positioning of one or more reconfigurable supports 600, whether in a first configuration, a second configuration, or other configurations for the reconfigurable supports 600. The sensor(s) 560 and operations thereof is discussed in greater detail, below, with respect to FIG. 11. Further, the first magnetic connector(s) 540a are positioned proximate to one or more of the perimeter 535b, the recessed ledge 536b, or combinations thereof and are configured for magnetically engaging with the reconfigurable support 600b, for positioning the reconfigurable support 600b in at least the first and second configurations.

To that end, FIG. 8C illustrates the recess 534b, wherein the reconfigurable support 600b is magnetically engaged with the housing. Specifically, the first edge 611b of the reconfigurable support 600b abuts the recessed ledge 536b, in a first configuration 651, which may be a surface configuration. In some examples, as illustrated, the reconfigurable support 600b is magnetically engaged with the housing via magnetic connection between the first magnetic connector 540a and a second magnetic connector 640b that forms part of the reconfigurable support 600b, as discussed in the examples above.

When the reconfigurable support 600b is positioned in the first configuration 651, the resilient protrusion 630b extends outward from the bottom surface 532b of the housing. When the reconfigurable support 600b is positioned in the first configuration 651 and the playback device 410, for example, rests on the surface 404, the reconfigurable support 600b is configured to support the playback device 410 and elevate the bottom surface 532b of the playback device 410 above the surface 404. In such examples, the bottom surface 532b may be elevated above the surface 404 by a height (H_{E}), which may be configured for providing enough separation between the surface 404 and the bottom surface 532b for proper ventilation and cooling. In such examples, H_{E} may be configured such that one or more of a fan, a heat sink, a vent, or combinations thereof, of the playback device 410 has enough room underneath the device for proper air ingress and heat egress, for proper thermal performance for the playback device 410. Further still, H_{E} may be configured such that an acoustic performance or fidelity for the device is not compromised by a transducer 414 resting too close to the surface 404. In some examples, H_{E} may be in a range of about 10 millimeters (mm.) to about 100 mm.

FIG. 8D is another cross-sectional sideview of the recess 534b and the reconfigurable support 600b; however, in the illustration of FIG. 8D, the reconfigurable support 600b is positioned within the recess 534b in a second position 652, which may be a position configured for stowing the reconfigurable support 600b, when the playback device 410 is to be mounted (e.g., the example of FIG. 4B). In such examples, the second edge 621b of the second side 621b of the reconfigurable support 600b is magnetically engaged with the recessed ledge 536b, via, for example, the first and second magnetic connectors 540b, 640b, and the resilient protrusion 630b is substantially contained within the recess 534b. In some such examples, when the reconfigurable support 600b is positioned in the second configuration 652, the first side 610b and/or the first edge 611b, thereof, is substantially flush with the bottom surface 532b of the housing. Thus, in the second configuration 652, as illustrated in FIG. 8D, the reconfigurable support 600b may be substantially unnoticeable by a user and/or may not substantially protrude from the bottom surface 532b. Accordingly, utilizing the second configuration 652 in a mounted-device scenario may obscure view of the reconfigurable support 600b, may avoid any unwanted protrusions touched or seen by the user or other beings in the vicinity of the playback device 410, and/or the second configuration may stow away the reconfigurable support 600b safely and with the playback device 410. As noted above, this allows a user to easily switch to the first configuration 651, for a surface positioned configuration for the playback device 410, if he/she/they desire such a configuration for future use of the playback device 410.

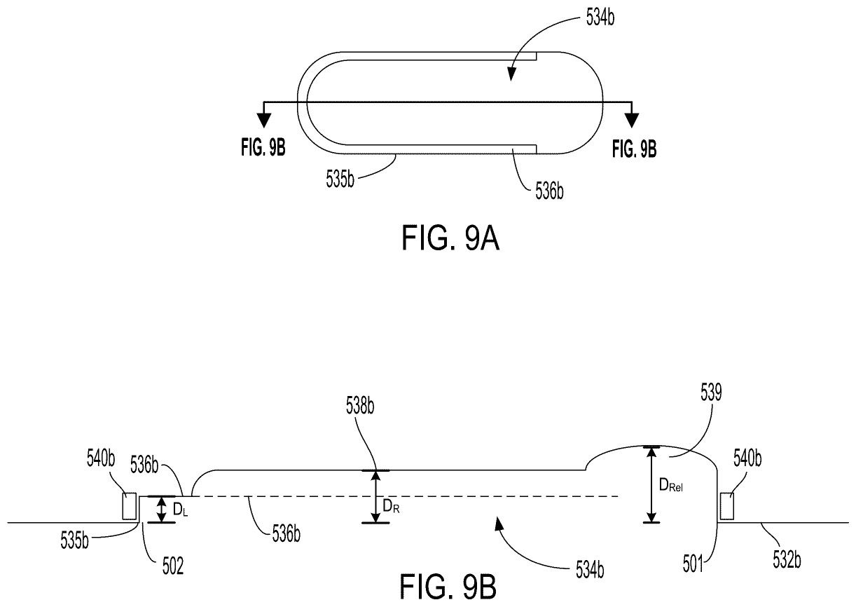

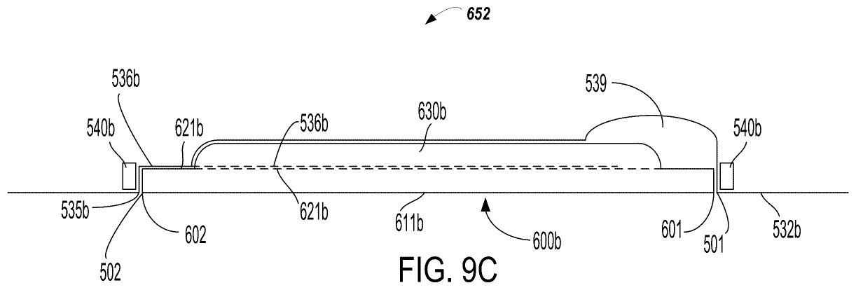

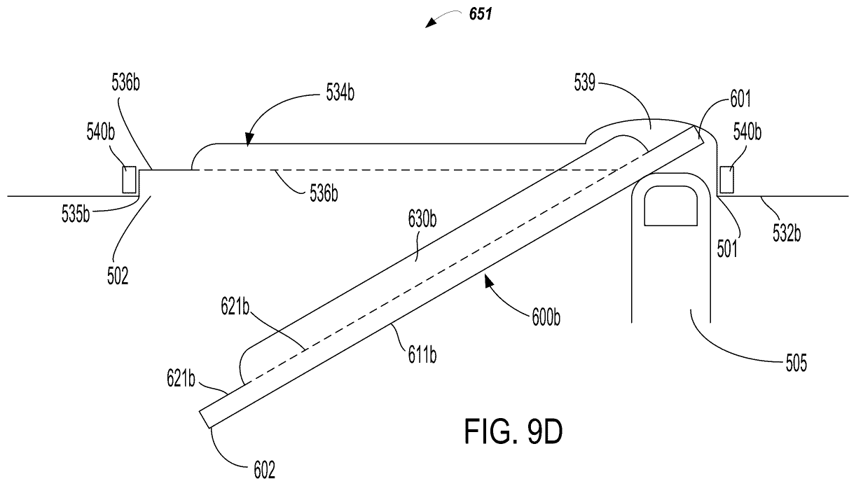

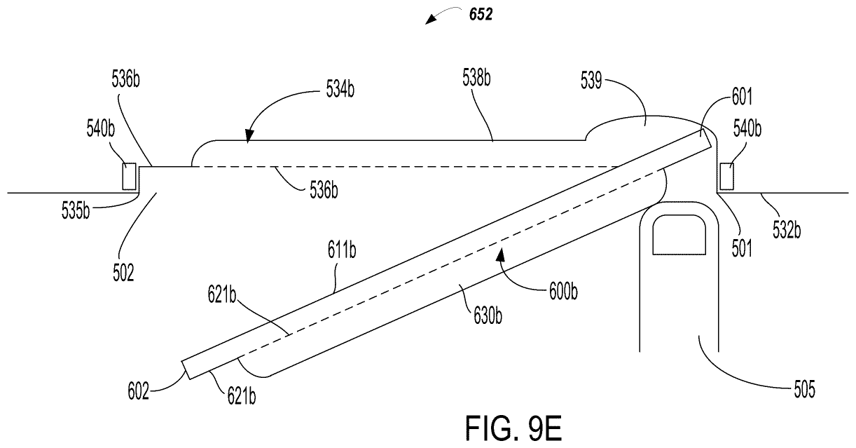

FIGS. 9A-9D are illustrative of further examples of the housing and associated recess that may be used in conjunction with the reconfigurable supports discussed herein. Although the following examples will refer to the housing 530b and the associated recess 534b discussed in FIGS. 8A-8C, it should be understood that the features discussed and shown in FIGS. 9A-9D may also be applied to the examples shown in FIGS. 6A-6C, among other examples.

Beginning with FIG. 9A, a top-down view of the recess 534b is shown. As discussed above, the recess 534b may define or include a perimeter 535b and a recessed ledge 536b, the recessed ledge 536b extending about at least a portion of the perimeter 535b of the recess 534b. FIG. 9A also indicates the location of the cross-sectional view of the recess 534b that is shown in FIGS. 9. In this regard, the portions of the recessed ledge 536b along the two linear sides of the recess 534b—parallel to the cross-section line—are represented in FIG. 9B-9E by a dashed line.

As illustrated in FIGS. 9B-9E, the housing 530b may further define a release recess 539 that is configured to allow for removal or repositioning of the reconfigurable support 600b by depressing either a first end 601 or a second end 602 of the reconfigurable support 600b into the release recess 539, when the respective end 601, 602 is positioned proximate to the release recess 539. To facilitate this interaction, the recessed ledge 536b may not extend about the entire perimeter 535b of the recess, as generally discussed above. Rather, as illustrated in FIGS. 9A-9E, (and as previously shown in FIGS. 8A-8D), the recessed ledge 536b may terminate before it reaches a first end 501 of the recess 534b. Accordingly, when the reconfigurable support 600b is in either the first configuration 651 or the second configuration 652, the end of the reconfigurable support 600b that is positioned over the release recess 539 is cantilevered over the first end 501 of the recess 534b. Accordingly, the end of the reconfigurable support 600b is depressible into the first end 501 of the recess 534b, due to the inclusion of the release recess 539 and the absence of the recessed ledge 536b at the first end 501. When the end of the reconfigurable support 600b is depressed in this manner (see FIG. 9D), the opposite end of the reconfigurable support 600b is raised out of a second end 502 of the recess, thereby enabling removal of the reconfigurable support 600b from the recess 534b. Such functionality may be better understood with reference to FIGS. 9B-E.

To that end, FIG. 9B illustrates the recess 534b, including the release recess 539 and absent the reconfigurable support 600b positioned therein. In the example of FIG. 9B, the release recess 539 has a release depth (D_{REL}), which is greater than D_{R}. This may be necessary in implementations where the depth of the recess 534b, D_{R}, is substantially similar to the overall height of the reconfigurable support 600b, leaving little or no space between the resilient protrusion 630b and the deepest point 538b of the recess 534b when in the second configuration 652. Accordingly, to be able to depress an end 601, 602 of the reconfigurable support 600b such that the opposing end 601, 602 rises for removal, D_{REL} may need to be greater than D_{R}. FIG. 9C illustrates the reconfigurable support 600b positioned within the recess 534b in the second configuration 652. For instance, as discussed above, the reconfigurable support 600b may be engaged within the recess via the magnetic connection between magnetic connectors 540b, 640b. As illustrated, the first end 601 of the configurable support 600a is positioned proximate to the release recess 539 and, as illustrated in FIG. 9D, is depressible into the release recess 539 so as to raise the second end 602, for removal or reconfiguration of the reconfigurable support 600b.

FIGS. 9D and 9E illustrate, respectfully, the reconfigurable support 600b in its second and first configurations 652, 651, but with the first end 601 depressed by a finger 505 of a user pressing on the first end 601 of the reconfigurable support 600b in order to raise the opposite end 602 out of the recess 534b. In this regard, the end of the reconfigurable support 600b residing above or proximate to the release recess 539 may be referred to as a “depressible end” of the reconfigurable support 600b.

Although the examples depicted above involve a recess 534b that includes a release recess 539 therein, other arrangements are also possible. For instance, in some other implementations, the depth of the recess 534b, D_{R}, may be greater than the overall height of the reconfigurable support 600b such that, when the reconfigurable support 600b is stowed in the second configuration 652, there is sufficient clearance between the resilient protrusion 630b and the deepest point 538b of the recess 534b to perform the operation shown in FIG. 9D. As another possibility, and with reference to FIG. 9C, the depth of the recess 534b, D_{R}, may be substantially similar to the overall height of the reconfigurable support 600b. However, the resilient protrusion 630b may not extend within the recess 534b to the extent shown in the previous examples. Rather, similar to the recessed ledge 536b, the resilient protrusion 630b may terminate short of the ends 601, 601 of the reconfigurable support 600b. This, in turn, may allow a cantilevered end of the reconfigurable support 600b in the second configuration 652 to be depressed into the recess, due to the absence of both the recessed ledge 536b and the resilient protrusion 630b. Other arrangements are also possible.

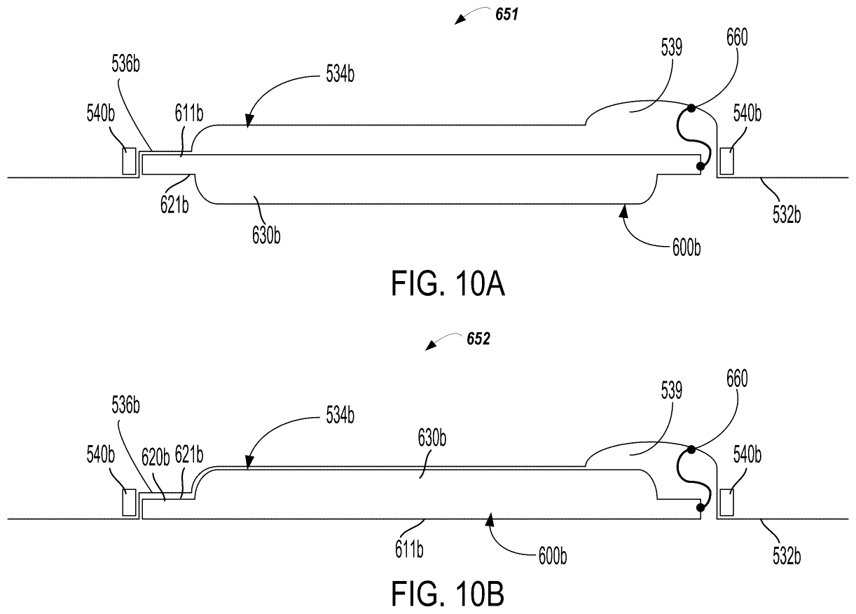

FIGS. 10A, 10B, respectively, illustrate the reconfigurable support 600b in the first configuration 651 and the second configuration 652, but in addition to residing, at least in part, within the recess 534b, the reconfigurable support 600b is further attached to the housing and/or the recess 534b via a flexible tether 660. The flexible tether 660 connects the reconfigurable support 600b and the housing such that, when the reconfigurable support 600b is positioned within the recess 534b in either the first or second configuration 651, 652, the flexible tether 660 is stowable within the recess 534b. As illustrated, in some examples, the flexible tether 660 may be stowable in and/or affixed to the release recess 539; however, the flexible tether 660 need not be limited to residing within the release recess 539 and may be connected to the recess 534b at any point therein. The flexible tether 660 may be any connecting material or apparatus suitable for attaching the reconfigurable support 600b to the housing, while allowing for flexible reconfiguration of the reconfigurable support 600b from the first configuration 561 to the second configuration 562 and vice versa. The flexible tether 660 may be, for example, a wire, a string, a rope, a flexible plastic, a stretchable polymer, among other contemplated apparatus or materials for flexibly connecting the reconfigurable support 600b to the housing.

While a single reconfigurable support 600 and associated recess 534 in the housing 530 are illustrated above with respect to FIGS. 5A-10B, it is certainly contemplated that the playback device 410 and/or the housing 530 thereof may include or be associated with any number of reconfigurable supports 600 and define or include any number of associated recesses 534 therein. To that end, in some examples, such as the illustrated example of FIGS. 4A-4B, the playback device 410 and/or the housing 530 thereof may further include a second recess 534 formed in the bottom surface 532 of the housing 530, wherein the second recess 534 is spaced apart from the first recess 534 and may be substantially similar and/or identical to the first recess 534 of the housing 530. In some such examples, the playback device 410 and/or the housing 530 thereof may further include a second reconfigurable support 600, which may be substantially similar and/or identical to the first reconfigurable support 600.

FIG. 11 is a flowchart showing example operations for detecting positioning of the reconfigurable support(s) 600 of FIGS. 4-10B and, optionally, alerting a user of the device to said positioning. As discussed above, operations related to the playback device 410 and/or other aforementioned playback device(s) 110 (e.g. a method 700 of FIG. 11), discussed herein, may be operable via at least one processor, a non-transitory computer-readable medium, and program instructions stored on the computer readable medium that are executable by the at least one processor to cause the playback device(s) to execute the operations of FIG. 11.

Beginning at block 702, a computing device (e.g., the playback device 410) may receive data from one or more sensors 560. At block 704, based on data provided by the sensor(s) 560, the playback device 410 may detect a position of the reconfigurable support 600 within the recess 534. In some examples, the sensor(s) 560 may be a Hall effect sensor, configured for detecting a magnetic field associated with the reconfigurable support 600, when the reconfigurable support 600 and/or a component thereof (e.g., the magnetic connector 640) is proximate to the Hall effect sensor. In some implementations, the magnetic connector 640 may be arranged in the reconfigurable support 600 such that the magnetic field detected by the Hall effect sensor (or multiple Hall effect sensors) differs when the reconfigurable support 600 is in the first configuration 651 versus the second configuration 652. Additionally or alternatively, the sensor(s) 560 may include a proximity sensor (e.g., an optical sensor) configured to detect if an object, such as the reconfigurable support 600, is proximate to the housing 530 and/or the recess 534. In this regard, the proximity sensor may be used to determine whether the reconfigurable support 600 is positioned within the recess or removed, and if positioned within the recess, whether it is in the first configuration 651 or the second configuration 652. For example, a proximity sensor 560 may detect whether the resilient protrusion of the reconfigurable support is contained within the recess when the reconfiguration support is engaged with the housing, which may indicate that the reconfigurable support is in the second position 652. Other arrangements using combinations of the above and/or other types of sensors are also possible.

At block 706, the playback device 410 determines, based on sensor data, that the bottom surface of the playback device 410 is resting on a surface 404 and that the reconfigurable support 600 is positioned within the recess 534 in the second configuration 562. In this regard, the playback device 410 may determine that it is resting on a surface in various ways. For instance, sensor data collected by one or more sensors associated with a mounting interface of the playback device 410 (e.g., a threaded connection, a bracket, etc.) may indicate that the mounting interface is in use when the playback device 410 is in a mounted configuration. In a similar way, the same sensor(s) may indicate that the mounting interface is not being used, which may imply that the playback device 410 is not in a mounted configuration, but rather resting on a surface. Further discussions on determining the positioning of a playback device can be found in U.S. Pat. No. 8,995,240 entitled “Playback Using Positioning Information,” which is incorporated by reference herein in its entirety. As another possibility, sensor data collected by one or more movement/orientation sensors (e.g., a gyroscope, accelerometer, magnetometer, inertial measurement unit, etc.) may indicate whether the playback device 410 is in a mounted configuration or a surface configuration. In some cases, the sensor(s) may detect movement of the playback device 410 during playback due to the vibrations created by the audio transducer(s) 414, which may indicate that the reconfigurable support 600 is not positioned in the correct configuration—i.e., the first configuration 651—to mitigate such movements. Further discussions on detecting movement of a playback device during playback can be found in U.S. Pat. No. 10,007,481 entitled “Detecting and Controlling Physical Movement of a Playback Device During Audio Playback,” which is incorporated by reference herein in its entirety.

At block 708, based on determining that the bottom surface of the playback device 410 is resting on the surface 404 and that the reconfigurable support 600 is positioned within the recess 534 in the second configuration 652, the playback device 410 may generate an audible notification via at least one transducer 414 of the playback device 410. The audible notification may serve as an indication that the reconfigurable supports 600 are incorrectly configured.

The playback device 410 may additionally or alternatively take various other actions as well. For instance, as shown in FIG. 11, the playback device 410 may, at block 710, transmit, to a second computing device installed with software for controlling the playback device 410 (e.g., one or more of the control devices 130 discussed above), data indicating the position of the reconfigurable supports 600 within the recess. This may cause the second computing device to display a notification advising a user that the reconfigurable support(s) 600 are incorrectly configured and suggesting that the user reposition them into the first configuration 651.

As yet another possibility, the playback device 410 may adjust one or more audio playback characteristics based on determining that the playback device 410 is resting on the surface 404 and that the reconfigurable support 600 is positioned within the recess 534 in the second configuration. For instance, the playback device 410 may impose a volume limit until the reconfigurable support 600 is repositioned to the first configuration 651. Various other implementations, including combinations of the above, are also possible.

FIG. 11 includes one or more operations, functions, or actions as illustrated by one or more of operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowchart shown in FIG. 11 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, cach block in FIG. 11 may represent circuitry and/or machinery that is wired or arranged to perform the specific functions in the process.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

Further, the examples described herein may be employed in systems separate and apart from media playback systems such as any Internet of Things (IoT) system comprising an IoT device. An IoT device may be, for example, a device designed to perform one or more specific tasks (e.g., making coffee, reheating food, locking a door, providing power to another device, playing music) based on information received via a network (e.g., a WAN such as the Internet). Example IoT devices include a smart thermostat, a smart doorbell, a smart lock (e.g., a smart door lock), a smart outlet, a smart light, a smart vacuum, a smart camera, a smart television, a smart kitchen appliance (e.g., a smart oven, a smart coffee maker, a smart microwave, and a smart refrigerator), a smart home fixture (e.g., a smart faucet, a smart showerhead, smart blinds, and a smart toilet), and a smart speaker (including the network accessible and/or voice-enabled playback devices described above). These IoT systems may also comprise one or more devices that communicate with the IoT device via one or more networks such as one or more cloud servers (e.g., that communicate with the IoT device over a WAN) and/or one or more computing devices (e.g., that communicate with the IoT device over a LAN and/or a PAN). Thus, the examples described herein are not limited to media playback systems.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing device comprising
one or more electronic components;
a housing configured for enclosing, at least in part, the one or more electronic components, the housing comprising:
a bottom surface; and
a recess formed in the bottom surface of the housing, the recess comprising a perimeter and a recessed ledge extending about at least a portion of the perimeter of the recess; and
a reconfigurable support, the reconfigurable support comprising:
a first side comprising a first edge that is substantially planar; and
a second side opposite the first side, the second side comprising a second edge that is substantially planar and parallel to the first edge, the second edge surrounding a resilient protrusion that extends outward from a plane of the second edge, wherein:
when the reconfigurable support is positioned within the recess in a first configuration, the first edge is magnetically engaged with the recessed ledge and the resilient protrusion extends outward from the bottom surface of the housing; and
when the reconfigurable support is positioned within the recess in a second configuration, the second edge is magnetically engaged with the recessed ledge and the resilient protrusion is contained within the recess.

2. The computing device of claim 1, wherein, when the reconfigurable support is positioned in the first configuration and the computing device rests on a surface, the reconfigurable support is configured to (i) support the computing device and (ii) elevate the bottom surface of the computing device above the surface.

3. The computing device of claim 1, wherein, when the reconfigurable support is positioned in the second configuration, the first side of the reconfigurable support is flush with the bottom surface of the housing.

4. The computing device of claim 3, wherein the first side of the reconfigurable support is substantially planar.

5. The computing device of claim 1, wherein the recess comprises a first end and a second end, and wherein the recessed ledge does not extend about the perimeter of the recess at the first end of the recess such that, when the reconfigurable support is positioned within the recess in either the first configuration or the second configuration, a first end of the reconfigurable support is depressable into the first end of the recess so as to raise a second end of the reconfigurable support out of the second end of the recess, thereby enabling removal of the reconfigurable support from the recess.

6. The computing device of claim 1, further comprising:
one or more sensors;
at least one processor;
a non-transitory computer-readable medium; and
program instructions stored on the non-transitory computer-readable medium that are executable by the at least one processor such that the computing device is configured to:
detect, via the one or more sensors, a position of the reconfigurable support within the recess.

7. The computing device of claim 6, wherein the one or more sensors comprises at least one of a Hall effect sensor or an optical sensor.

8. The computing device of claim 6, further comprising at least one loudspeaker and program instructions stored on the non-transitory computer-readable medium that are executable by the at least one processor such that the computing device is configured to:
determine, via the one or more sensors, that (i) the bottom surface of the computing device is resting on a surface and (ii) that the reconfigurable support is positioned within the recess in the second configuration; and
based on determining that (i) the bottom surface of the computing device is resting on the surface and (ii) that the reconfigurable support is positioned within the recess in the second configuration, generate an audible notification via the at least one loudspeaker.

9. The computing device of claim 6, further comprising program instructions stored on the non-transitory computer-readable medium that are executable by the at least one processor such that the computing device is configured to:
transmit, to a second computing device installed with software for controlling the computing device, data indicating the position of the reconfigurable support within the recess.

10. The computing device of claim 1, wherein the recess is a first recess and the reconfigurable support is a first reconfigurable support, and wherein the computing device further comprises:
a second recess formed in the bottom surface of the housing, the second recess spaced apart from the first recess and identical to the first recess; and
a second reconfigurable support, the second reconfigurable support identical to the first reconfigurable support.

11. The computing device of claim 1, wherein the reconfigurable support comprises:
a resilient first layer forming the first side;
a resilient second layer forming the second side, wherein the resilient protrusion is integrally formed with the resilient second layer; and
a rigid layer affixed to, and positioned in between, the resilient first layer and the resilient second layer.

12. The computing device of claim 1, further comprising a flexible tether that connects the reconfigurable support and the housing, wherein, when the reconfigurable support is positioned within the recess in either the first configuration or the second configuration, the flexible tether is stowable within the recess.

13. The computing device of claim 1, wherein the resilient protrusion is comprised of one or more of a silicon material, a rubber material, or combinations thereof.

14. A reconfigurable support comprising:
a first side comprising a first edge that is substantially planar, the first edge configured for magnetic engagement with a recessed ledge of a recess formed in a bottom surface of a housing, the recess comprising a perimeter, and the recessed ledge extending about at least a portion of the perimeter of the recess; and
a second side opposite the first side and configured for magnetic engagement with the recessed ledge, the second side comprising a second edge that is substantially planar and parallel to the first edge, the second edge surrounding a resilient protrusion that extends outward from a plane of the second edge, wherein:
when the reconfigurable support is positioned within the recess in a first configuration, the first edge is magnetically engaged with the recessed ledge and the resilient protrusion extends outward from the bottom surface of the housing; and
when the reconfigurable support is positioned within the recess in a second configuration, the second edge is magnetically engaged with the recessed ledge and the resilient protrusion is contained within the recess.

15. The reconfigurable support of claim 14, wherein, when the reconfigurable support is positioned in the first configuration, the reconfigurable support is configured to elevate the bottom surface of the housing above a surface.

16. The reconfigurable support of claim 14, wherein, when the reconfigurable support is positioned in the second configuration, the first side of the reconfigurable support is flush with the bottom surface of the housing.

17. The reconfigurable support of claim 14, wherein the recess comprises a first end and a second end, and wherein the recessed ledge does not extend about the perimeter of the recess at the first end of the recess such that, when the reconfigurable support is positioned within the recess in either the first configuration or the second configuration, a first end of the reconfigurable support is depressable into the first end of the recess so as to raise a second end of the reconfigurable support out of the second end of the recess, thereby enabling removal of the reconfigurable support from the recess.

18. The reconfigurable support of claim 15, further comprising:
a resilient first layer forming the first side;
a resilient second layer forming the second side, wherein the resilient protrusion is integrally formed with the resilient second layer; and
a rigid layer affixed to, and positioned in between, the resilient first layer and the resilient second layer.

19. A playback device comprising:
at least one transducer;
a housing configured for enclosing, at least in part, the at least one transducer, the housing comprising:
a bottom surface; and
a recess formed in the bottom surface of the housing, the recess comprising a perimeter and a recessed ledge extending about at least a portion of the perimeter of the recess; and
a reconfigurable support, the reconfigurable support comprising:
a first side comprising a first edge that is substantially planar; and
a second side opposite the first side, the second side comprising a second edge that is substantially planar and parallel to the first edge, the second edge surrounding a resilient protrusion that extends outward from a plane of the second edge, wherein:
when the reconfigurable support is positioned within the recess in a first configuration, the first edge is magnetically engaged with the recessed ledge and the resilient protrusion extends outward from the bottom surface of the housing; and
when the reconfigurable support is positioned within the recess in a second configuration, the second edge is magnetically engaged with the recessed ledge and the resilient protrusion is contained within the recess.

20. The playback device of claim 19, further comprising:
one or more sensors;
at least one processor;
a non-transitory computer-readable medium; and
program instructions stored on the non-transitory computer-readable medium that are executable by the at least one processor such that the playback device is configured to:
detect, via the one or more sensors, a position of the reconfigurable support within the recess;
determine, via the one or more sensors, that (i) the bottom surface of the playback device is resting on a surface and (ii) that the reconfigurable support is positioned within the recess in the second configuration; and
based on determining that (i) the bottom surface of the playback device is resting on the surface and (ii) that the reconfigurable support is positioned within the recess in the second configuration, generate an audible notification via the at least one transducer.
